(19) United States
(12) Patent Application Publication
(10) Pub. No.: US 2009/0182772 A1
(43) Pub. Date: Jul. 16, 2009

(54) METHODS AND SYSTEMS FOR IMPLEMENTING STAGED CONFIGURATOR MODELING

(75) Inventors: William Brand, Tewksbury, MA (US); Martin Plotkin, Concord, MA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 12/014,627

(22) Filed: Jan. 15, 2008

(51) Int. Cl. G06F 7/00; G06F 17/30

(52) U.S. Cl. 707/104.1; 707/E17.011

(57) ABSTRACT

This disclosure describes, generally, methods and systems for implementing staged configurator modeling. The method may include initiating a staged product configurator model environment and presenting a user interface (UI) configured to allow for definition of stages. The method may further include receiving input via the UI indicating the definition of stages and storing the stages in a data store. Furthermore, the method may include defining product components and associating product components with one or more of the stages. The method may further include executing one or more applications associated with the product components. The method may further include executing one or more applications associated with the product components. Each application may be configured to use the one or more stages when executing a configurator, and each new stage supplied to the configurator may be equal to or linearly incremented from a previously supplied stage.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates, in general, to the modeling of products and services with a configurator (“configurator modeling”) and, more particularly, to implementing staged modeling of products and services with a configurator (i.e., staged configurator modeling).

### BACKGROUND

Presently, businesses commonly use a hierarchical structure of items and options to organize both simple and complex products and/or services. This hierarchy is defined by the use of component relationships, which allow items to be further decomposed. This structure serves as a basis to further indicate how the products and services are to be marketed, priced, manufactured, assembled, provisioned, forecast, planned for, etc.

The hierarchical structure can be used to organize both sales options and the corresponding manufacturing options. This dual use of the data structure can result in a quoted product including both sales and manufacturing information, which is undesirable to many businesses and their customers. Businesses have typically dealt with this problem by “hiding” the unwanted information or by separating the hierarchical data into separate sales and manufacturing structures. However, both approaches duplicate maintenance activities and require additional integration or custom software to be developed between the sales ordering and fulfillment systems. Hence, there is a need for improved methods and systems in the art.

### BRIEF SUMMARY

Embodiments of the present invention are directed to a method of implementing staged configurator modeling. The method may include initiating a staged product configurator model environment and presenting a user interface (UI) configured to allow for definition of stages. The method may further include receiving input via the UI indicating the definition of stages and storing the stages in a data store.

Furthermore, the method may include defining product components and associating product components with one or more of the stages. The method may further include executing one or more applications associated with the product components. The applications may be configured to linearly increment through the stages. The method may further include generating runtime constraints for each of the stages and enforcing the runtime constraint for a current stage by displaying only product components associated with the current stage or any previous stage.

According to further embodiments, a system for implementing staged configurator modeling is described. The system may include a product information manager (PIM) having a product database and a stage value storage device. In one embodiment, the PIM may be configured to define product components, to store the defined product components in the product database, and to store one or more stages in the stage value storage device.

The system may further include a configurator coupled with the PIM. In one embodiment, the configurator may present a UI configured to allow for definition of stages. The configurator (or the PIM) may receive input via the UI indicating the definition of the one or more stages and associate product components with one or more of the one or more stages. The configurator may be called by an application associated with the product components. In one embodiment, the application may be configured to linearly increment through the one or more stages. The configurator may then generate runtime constraints for each of the one or more stages, and enforce the runtime constraint for a current stage by displaying only product components associated with the current stage or any previous stage.

In an alternative embodiment, a machine-readable medium is described. The machine-readable medium may include instructions for initiating a staged product configurator model environment and presenting a UI configured to allow for definition of stages. The machine-readable medium may further include instructions for receiving input via the UI indicating the definition of stages and storing the stages in a data store.

Furthermore, the machine-readable medium may include instructions for defining product components, and associating product components with one or more of the stages. The machine-readable medium may further include instructions for executing one or more applications that may be associated with the product components and may execute the configurator. Linear incrementation (or progression) through the stages may be performed by one or more than one of the applications. The machine-readable medium may further include instructions for generating runtime constraints for each of the stages and enforcing the runtime constraint for a current stage by displaying only product components associated with the current stage or any previous stage.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a generalized schematic diagram illustrating a computer system, in accordance with various embodiments of the invention.

FIG. 2 is a block diagram illustrating a networked system of computers, which can be used in accordance with various embodiments of the invention.

FIG. 3 is a flow diagram illustrating one aspect of staged configurator modeling.

FIG. 4 is a flow diagram illustrating another aspect of staged configurator modeling.

FIG. 5 is a flow diagram illustrating yet another aspect of staged configurator modeling.

FIG. 6 is a block diagram illustrating one embodiment of a system for implementing staged configurator modeling.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

Aspects of the present invention relate to allowing businesses to define multiple “stages” which reflect the hierarchical structure which is used during an order lifecycle. Such stages may be progressively linear and cumulative and can be viewed as discrete phases in the lifecycle of an order. Examples of stages may be a “sales stage”, a “manufacturing stage”, a “sales opportunity stage”, a “quote stage”, a “fulfillment stage”, etc. In one embodiment, the present invention may restrict items associated with a stage that are further down the hierarchical structure that have not yet been reached. Accordingly, a customer cannot inadvertently be shown manufacturing parts at the sales stage, thus confusing the customer.

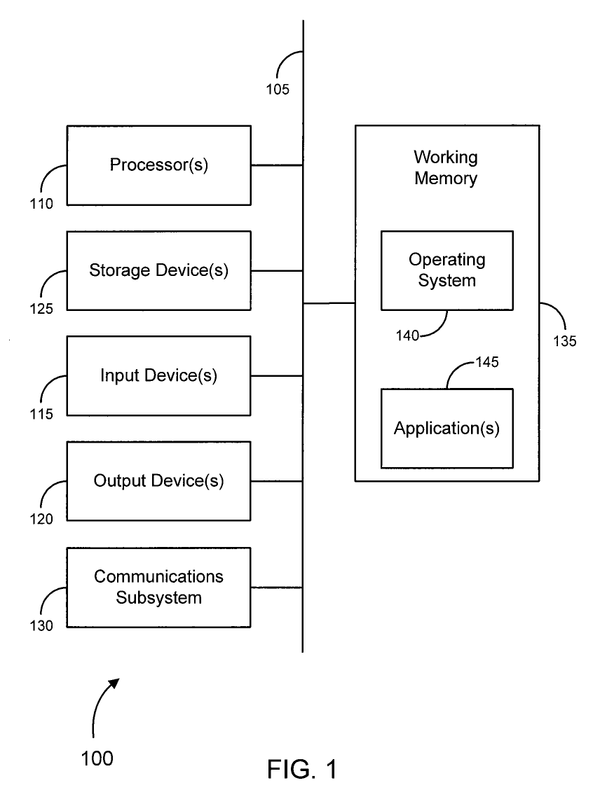

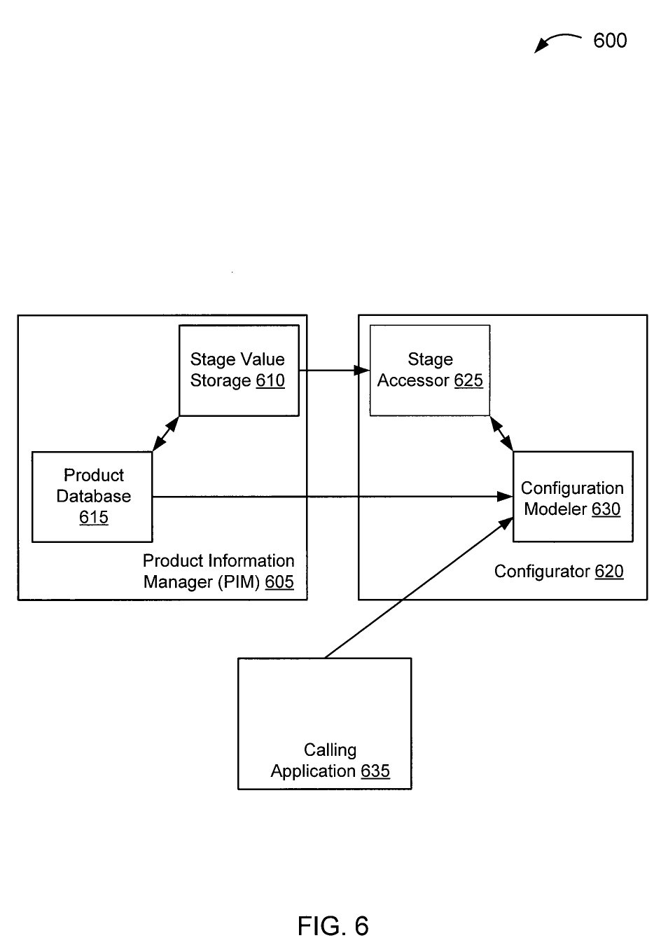

FIG. 1 provides a schematic illustration of one embodiment of a computer system 100 that can perform the methods of the invention, as described herein, and/or can function, for example, as any part of configurator 620 or product information manager (PIM) 605 in FIG. 6. It should be noted that FIG. 1 is meant only to provide a generalized illustration of various components, any or all of which may be utilized as appropriate. FIG. 1, therefore, broadly illustrates how individual system elements may be implemented in a relatively separated or relatively more integrated manner.

The computer system 100 is shown comprising hardware elements that can be electrically coupled via a bus 105 (or may otherwise be in communication, as appropriate). The hardware elements can include one or more processors 110, including without limitation one or more general-purpose processors and/or one or more special-purpose processors (such as digital signal processing chips, graphics acceleration chips, and/or the like); one or more input devices 115, which can include without limitation a mouse, a keyboard and/or the like; and one or more output devices 120, which can include without limitation a display device, a printer and/or the like.

The computer system 100 may further include (and/or be in communication with) one or more storage devices 125, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 100 might also include a communications subsystem 130, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 130 may permit data to be exchanged with a network (such as the network described below, to name one example), and/or any other devices described herein. In many embodiments, the computer system 100 will further comprise a working memory 135, which can include a RAM or ROM device, as described above.

The computer system 100 also can comprise software elements, shown as being currently located within the working memory 135, including an operating system 140 and/or other code, such as one or more application programs 145, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 125 described above. In some cases, the storage medium might be incorporated within a computer system, such as the system 100. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 100 and/or might take the form of source and/or installable code, which, upon compilation and/or installation on the computer system 100 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 100) to perform methods of the invention. According to a set of embodiments, some or all of the procedures of such methods are performed by the computer system 100 in response to processor 110 executing one or more sequences of one or more instructions (which might be incorporated into the operating system 140 and/or other code, such as an application program 145) contained in the working memory 135. Such instructions may be read into the working memory 135 from another machine-readable medium, such as one or more of the storage device(s) 125. Merely by way of example, execution of the sequences of instructions contained in the working memory 135 might cause the processor(s) 110 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 100, various machine-readable media might be involved in providing instructions/code to processor(s) 110 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 125. Volatile media includes, without limitation dynamic memory, such as the working memory 135. Transmission media includes coaxial cables, copper wire and fiber optics, including the wires that comprise the bus 105, as well as the various components of the communication subsystem 130 (and/or the media by which the communications subsystem 130 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 110 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 100. These signals, which might be in the form of electromagnetic signals, acoustic signals, optical signals and/or the like, are all examples of carrier waves on which instructions can be encoded, in accordance with various embodiments of the invention.

The communications subsystem 130 (and/or components thereof) generally will receive the signals, and the bus 105 then might carry the signals (and/or the data, instructions, etc., carried by the signals) to the working memory 135, from which the processor(s) 105 retrieves and executes the instructions. The instructions received by the working memory 135 may optionally be stored on a storage device 125 either before or after execution by the processor(s) 110.

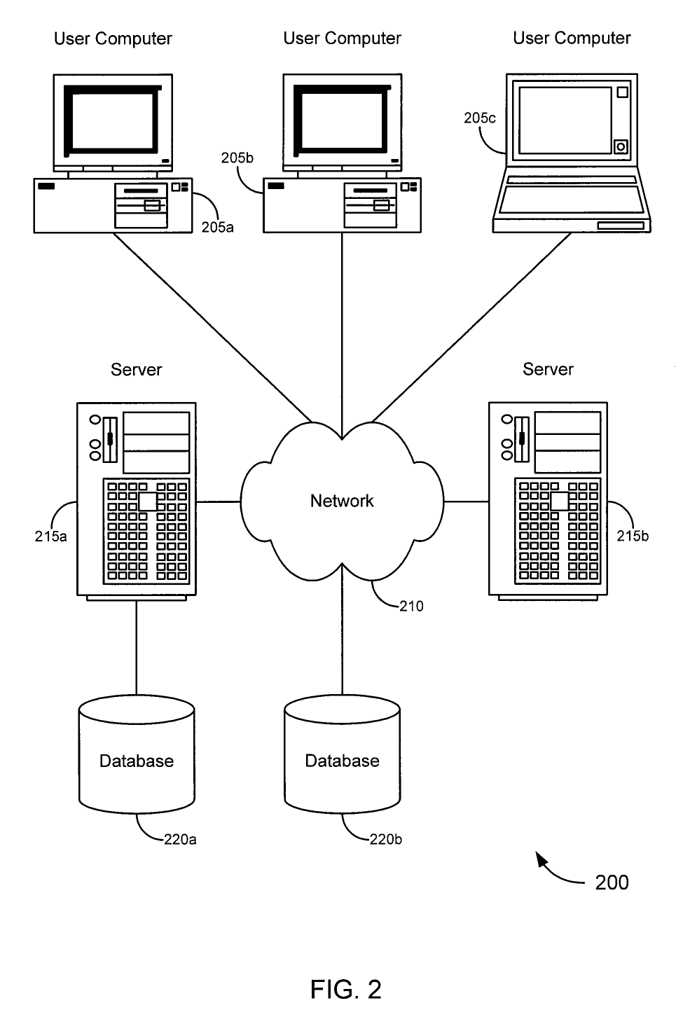

A set of embodiments comprises systems for implementing staged configurator modeling. In one embodiment, user computers 205 and/or servers 215 may be implemented as computer system 100 in FIG. 1. Merely by way of example, FIG. 2 illustrates a schematic diagram of a system 200 that can be used in accordance with one set of embodiments. The system 200 can include one or more user computers 205. The user computers 205 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 205 can also have any of a variety of applications, including one or more applications configured to perform methods of the invention, as well as one or more office applications, database client and/or server applications, and web browser applications. Alternatively, the user computers 205 can be any other electronic device, such as a thin-client computer, Internet-enabled mobile telephone, and/or personal digital assistant (PDA), capable of communicating via a network (e.g., the network 210 described below) and/or displaying and navigating web pages or other types of electronic documents. Although the exemplary system 200 is shown with three user computers 205, any number of user computers can be supported.

Certain embodiments of the invention operate in a networked environment, which can include a network 210. The network 210 can be any type of network familiar to those skilled in the art that can support data communications using any of a variety of commercially-available protocols, including without limitation TCP/IP, SNA, IPX, AppleTalk, and the like. Merely by way of example, the network 210 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 215. Each of the server computers 215 may be configured with an operating system, including without limitation any of those discussed above, as well as any commercially (or freely) available server operating systems. Each of the servers 215 may also be running one or more applications, which can be configured to provide services to one or more clients 205 and/or other servers 215.

Merely by way of example, one of the servers 215 may be a web server, which can be used, merely by way of example, to process requests for web pages or other electronic documents from user computers 205. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 205 to perform methods of the invention.

The server computers 215, in some embodiments, might include one or more application servers, which can include one or more applications accessible by a client running on one or more of the client computers 205 and/or other servers 215. Merely by way of example, the server(s) 215 can be one or more general purpose computers capable of executing programs or scripts in response to the user computers 205 and/or other servers 215, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configurator, database clients, API clients, web browsers, etc.) running on a user computer 205 and/or another server 215. In some embodiments, an application server can create web pages dynamically for displaying the information in accordance with embodiments of the invention, such as information displayed from PIM 605 or configurator 620 in FIG. 6. Data provided by an application server may be formatted as web pages (comprising HTML, Javascript, etc., for example) and/or may be forwarded to a user computer 205 via a web server (as described above, for example). Similarly, a web server might receive web page requests and/or input data from a user computer 205 and/or forward the web page requests and/or input data to an application server. In some cases a web server may be integrated with an application server.

In accordance with further embodiments, one or more servers 215 can function as a file server and/or can include one or more of the files (e.g., application code, data files, etc.) necessary to implement methods of the invention incorporated by an application running on a user computer 205 and/or another server 215. Alternatively, as those skilled in the art will appreciate, a file server can include all necessary files, allowing such an application to be invoked remotely by a user computer 205 and/or server 215. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 220. The location of the database(s) 220 is discretionary: merely by way of example, a database 220a might reside on a storage medium local to (and/or resident in) a server 215a (and/or a user computer 205). Alternatively, a database 220b can be remote from any or all of the computers 205, 215, so long as the database can be in communication (e.g., via the network 210) with one or more of these. In a particular set of embodiments, a database 220 can reside in a storage-area network (“SAN”) familiar to those skilled in the art. (Likewise, any necessary files for performing the functions attributed to the computers 205, 215 can be stored locally on the respective computer and/or remotely, as appropriate.) In one set of embodiments, the database 220 can be a relational database, such as an Oracle™ database, that is adapted to store, update, and retrieve data in response to SQL-formatted commands. The database might be controlled and/or maintained by a database server, as described above, for example.

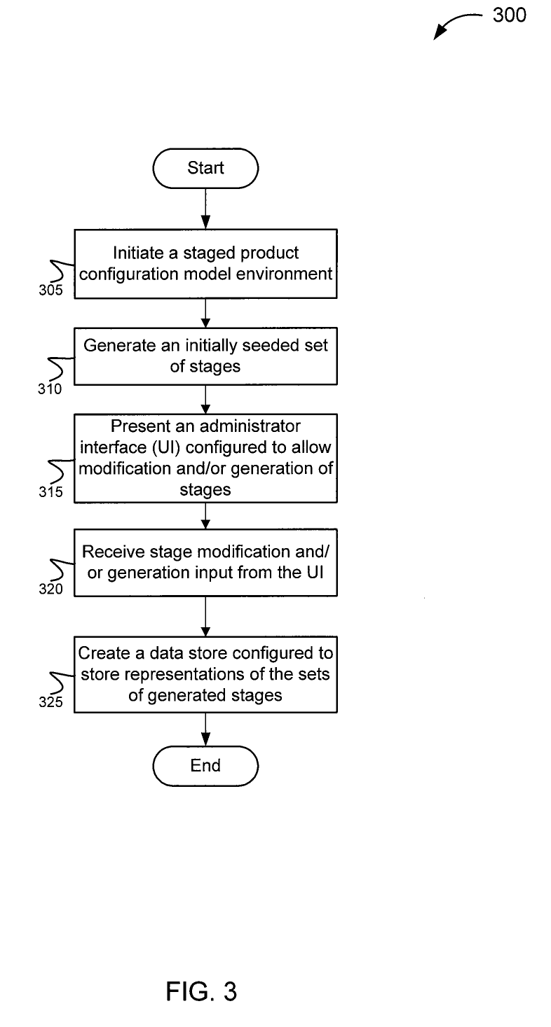

In one embodiment, server 215 or user computer 205 may be used to implement methods 300, 400, and 500 in FIGS. 3, 4 and 5. Furthermore, server 215 may be implemented as PIM 605 or configurator 620 in FIG. 6. Turning now to FIG. 3 which illustrates a method 300 for implementing staged configurator modeling. At process block 305, a staged product configurator environment may be initiated. In one embodiment, a staged product configurator environment may include establishing stages (or phases) within a hierarchical structure used to facilitate representation of an order lifecycle.

For example, a product lifecycle may begin with a customer choosing a product, customizing the product, completing the order, the product being manufactured, and then ends with the product being shipped to the customer. Each of these stages may have specific information related to what should or should not be accessible and/or displayed to the customer. For example, when the customer is customizing the product, it is unlikely that the customer would not need to see shipping or manufacturing information. Thus, with a staged product configurator environment, the customer is only able to see information related to their current stage or any previous stage.

At process block 310, in conjunction with the initializing of the staged product configurator model environment, a set of initially seeded stages may be generated. These initially seeded stages may be accessible to an administrator “out-of-the-box.” These initially seeded stages may include a “sales stage” and a “manufacturing stage”; however, additional or alternative stages may be used. In one embodiment, the administrator may use the initially seeded stages or may wish to add additional customized stages.

At process block 315, the administrator may be presented with a UI configured to allow the administrator to modify and/or generate stages. For example, the administrator's company may not be involved in the manufacturing process and would not have a need for the initially seeded manufacturing stage, therefore, the administrator may wish to remove or modify the manufacturing stage. Furthermore, the administrator's company may require additional stages, such as those mentioned above, in which the UI would allow creation of such stages.

At process block 320, input from the UI may be received. In one embodiment, the input may be directed at modifying the initially seeded stages, adding additional stages, or modifying added stages. The administrator may add, remove or modify as many stages as needed to satisfy the needs of the company. This effectively allows a company to completely customize/optimize stages to fit the company's business model/product lifecycle.

At process block 325, a data store may be created to store representations of the set of generated stages. In one embodiment, the data store may be a database maintained on a server system. In an alternative embodiment, the data store may be stored on a single system or may be stored on a distributed system. Nonetheless, the data store may be accessed to store new stage information as well as to identify stage information.

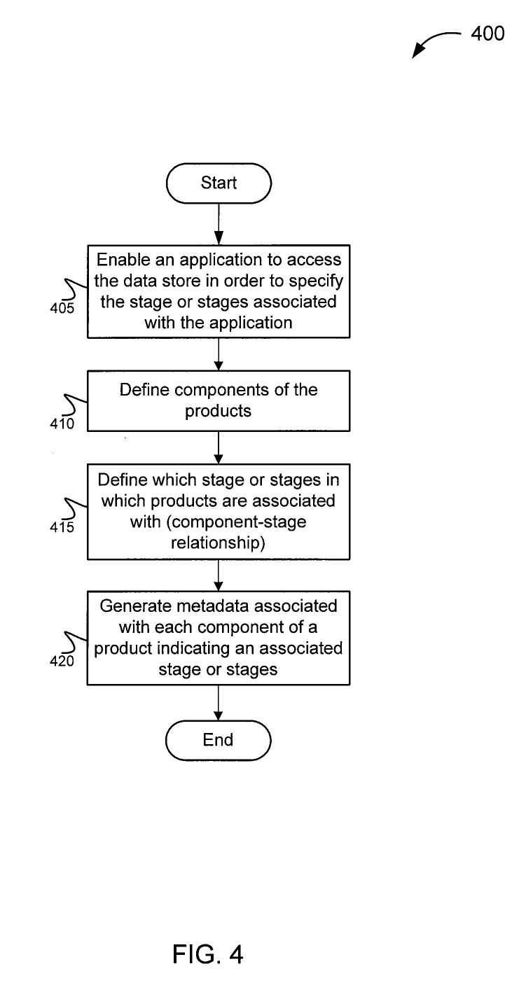

Turning now to FIG. 4, which illustrates a method 400 for implementing staged configurator modeling. In one embodiment, defined stages may be managed by a configurator. The configurator may be configured to execute and/or enforce constraints imposed by the defined stages. In addition, the applications may access the data store in order for the applications to be aware of the stages associated with each application (process block 405). In one embodiment, the application may be an integration point between the configurator and an end product. In another embodiment, the application may be one of a sales quote application, an order capture application, an installation application, a field service application, a distributed order application, etc.

Companies may have products related to a company's business model, and the products may also be broken down into components. Such components may be a piece or part of a whole product. At process block 410, components of products may be defined, thus creating product-components relationships. As such, one or more components can be grouped together to create a complete product (i.e., a product hierarchy). Such a product hierarchy may include not only component structures of a product and/or service, but may also include a hierarchy of attributes that may be set by the customer when ordering the product or its components. For example, attributes may include color, length, telephone number, warranty duration, etc.

At process block 415, components may be associated with one or more stages. This association creates a component-stage relationship. As such, by creating this relationship, each stage may be assigned certain components in which those assigned components are only viewable/accessible by its assigned stage. Accordingly, some components and attributes may only accessible to certain stages while being non-accessible to other stages.

In one embodiment, in response to the association of each component to a stage or stages, metadata may be generated and associated with each component to indicate the stage or stages associated with the component (process block 420). Accordingly, the metadata may be accessed to determine which stages a component are associated with, and therefore which stages are able to access the component.

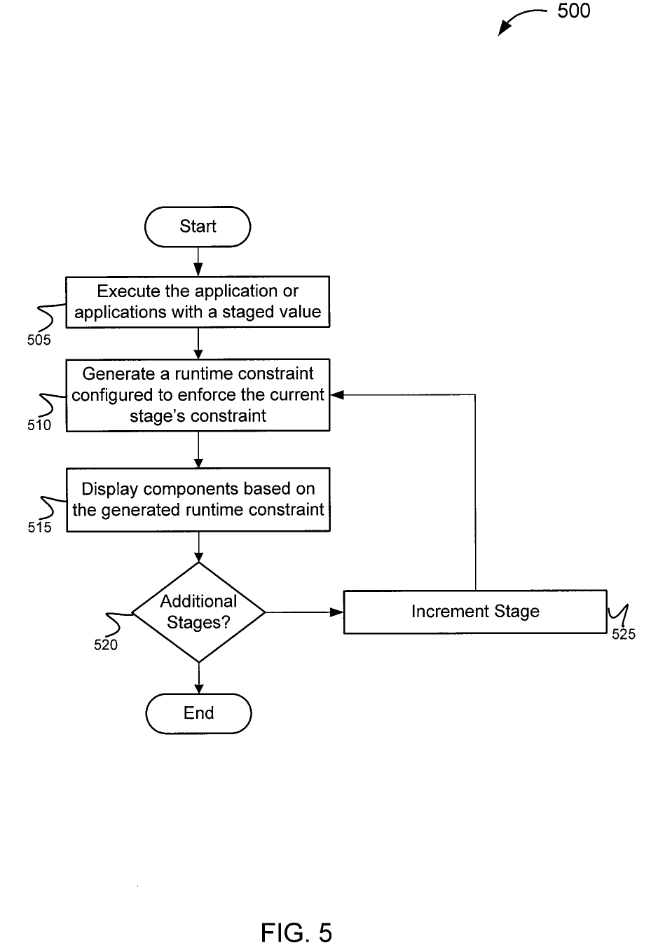

Turning now to FIG. 5, which illustrates a method 500 for implementing staged configurator modeling. At process block 505, the application or applications may be executed with a staged value. During execution of the application, a runtime constraint may be generated to enforce a current stage's constraints (process block 510). In one embodiment, the runtime constraints may be generated based on accessing the data store containing the component-stage designations. The runtime constraints generated for each stage may be configured to restrict components associated with later-stages from being included in the current stage. Accordingly, components associated with later stages in the product lifecycle are only available once the corresponding stage is reached. Stated differently, the runtime constraint restricts components associated with “downstream” stages from being incorrectly viewed by an “upstream” stage.

At process block 515, based on the runtime constraints the appropriate components may be displayed. At decision block 520, a determination is made whether additional stages exist. If no more additional stages exist, then the process ends; however, if additional stages exist, then the process is moved to process block 525 and the stage is incremented. After the stage is incremented, new runtime constraints may be generated based on the current (or incremented) stage designation. In one embodiment, the process continues until no additional stages are present.

Turning now to FIG. 6, which illustrates a system 600 for implementing staged configurator modeling. In one embodiment, system 600 may include a product information manager (PIM) 605. PIM 605 may include a stage value storage 610 and a product database 615. In one embodiment, PIM 605 may be a repository for bills of materials (BOMs), and product information. In one embodiment, a BOM may be a hierarchy of a number of products. Product database 615 may be configured to store the product information and BOMs.

In a further embodiment, stage value storage 610 may be configured to store stage information and stage-component relationship information. This stage-component relationship information may be accessed by configurator 620 via stage accessor 625. In one embodiment, after the stage-component relationship information is accessed, the stage-component relationship information is forwarded to configurator modeler 630 which is included in configurator 620. Subsequently, configurator modeler 630 generates runtime constraints used to enforce the stage restrictions. Furthermore, calling application 635 may access configurator 620 upon execution, in which configurator 620 may enforce the runtime constraints in relation to calling application 635.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A computer implemented method of implementing staged configurator modeling, the method comprising:
initiating a staged product configurator model environment;
presenting a user interface (UI) configured to allow for definition of stages;
receiving input via the UI indicating the definition of one or more stages;
storing the one or more stages in a data store;
defining product components;
associating product components with one or more of the one or more stages;
executing one or more applications associated with the product components, wherein each application is configured to use the one or more stages when executing a configurator, wherein each new stage supplied to the configurator is equal to or linearly incremented from a previously supplied stage;
generating runtime constraints for each of the one or more stages; and
enforcing the runtime constraint for a current stage by displaying only product components and attributes associated with the current stage.

2. The method of claim 1, wherein the one or more stages are at least one of a manufacturing stage, a sales stage, a quote stage, and an ordering stage.

3. The method of claim 1, further comprising initially seeding default stages.

4. The method of claim 3, further comprising modifying the initially seeded default stages.

5. The method of claim 1, wherein the UI is displayed on at least one of a mobile device, a portable computer, a handheld device, a cellular device, and a computer system.

6. The method of claim 1, further comprising granting each application access to specify stages specific to the application.

7. The method of claim 6, wherein the one or more applications are at least one of a sales quote application, an order capture application, an installation application, a field service application, and a distributed order application.

8. The method of claim 7, wherein the one or more applications are customized applications.

9. The method of claim 1, further comprising generating metadata associated with each product component indicating the one or more stages associated with the product component.

10. The method of claim 1, further comprising determining if there are additional stages.

11. The method of claim 10, further comprising:
if there are additional stages, incrementing to a next stage; and
enforcing a runtime constraint for the incremented stage by displaying only product components associated with the incremented stage.

12. A system for implementing staged configurator modeling, the system comprising:
a product information manager (PIM) including a product database and a stage value storage device, the PIM configured to define product components, to store the defined product components in the product database, and to store one or more stages in the stage value storage device;
a configurator coupled with the PIM, the configurator configured to present a UI configured to allow for definition of stages, to receive input via the UI indicating the definition of the one or more stages, to associate product components with one or more of the one or more stages, to generate runtime constraints for each of the one or more stages, and to enforce the runtime constraint for a current stage by displaying only product components associated with the current stage; and
one or more applications associated with the product components, wherein the one or more applications are configured to execute the configurator and based on the runtime constraints display only product components and attributes associated with a current stage.

13. The system of claim 12, wherein the configurator comprises a stage accessor configured to generate metadata associated with each product component indicating the stage associated with the product component.

14. The system of claim 12, wherein the configurator is further configured to initially seed default stages.

15. The system of claim 12, wherein the UI is further configured to receive input to modify the one or more stages.

16. The system of claim 12, wherein the configurator is further configured to grant the one or more applications access to specify stages specific to the application.

17. A machine-readable medium for implementing staged configurator modeling, having sets of instructions stored thereon which, when executed by a machine, cause the machine to:
initiate a staged product configurator model environment;
present a user interface (UI) configured to allow for definition of stages;
receive input via the UI indicating the definition of one or more stages;
store the one or more stages in a data store;
define product components;
associate product components with one or more of the one or more stages;
execute one or more applications associated with the product components, wherein each application is configured to use the one or more stages when executing a configurator, wherein each new stage supplied to the configurator is equal to or linearly incremented from a previously supplied stage;
generate runtime constraints for each of the one or more stages; and
enforce the runtime constraint for a current stage by displaying only product components associated with the current stage.

18. The machine-readable medium of claim 17, wherein the sets of instructions which, when executed by the machine, further cause the machine to initially seed default stages.

19. The machine-readable medium of claim 18, wherein the sets of instructions which, when executed by the machine, further cause the machine to modify the initially seeded default stages.

20. The machine-readable medium of claim 17, wherein the sets of instructions which, when executed by the machine, further cause the machine to grant the one or more applications access to specify stages specific to the application.

21. The machine-readable medium of claim 20, wherein the application is at least one of a sales quote application, an order capture application, an installation application, a field service application, and a distributed order application.
